(19) United States
(12) Patent Application Publication
(10) Pub. No.: US 2022/0103737 A1
(43) Pub. Date: Mar. 31, 2022

(54) ON-BOARD INFRARED ILLUMINATION DEVICE

(71) Applicant: KOITO MANUFACTURING CO., LTD., Tokyo (JP)

(72) Inventor: Mitsuyuki MOCHIZUKI, Shizuoka-shi (JP)

(73) Assignee: KOITO MANUFACTURING CO., LTD., Tokyo (JP)

(21) Appl. No.: 17/643,428

(22) Filed: Dec. 9, 2021

Related U.S. Application Data
(63) Continuation of application No. PCT/JP2020/022852, filed on Jun. 10, 2020.

(30) Foreign Application Priority Data
Jun. 17, 2019 (JP) 2019-112223

(51) Int. Cl. H04N 5/235; B60Q 1/00; B60Q 1/06

(52) U.S. Cl. CPC H04N 5/2352; B60Q 1/06; B60Q 1/0017

(57) ABSTRACT

An on-board infrared illumination device includes an infrared light source that provides for-camera infrared illumination by irradiating, with infrared radiation, a plurality of irradiation areas included in an imaging range within an exposure time of an on-board infrared camera, a light source controller configured to control the infrared light source to form a plurality of irradiation patterns at a timing different from a timing for the for-camera infrared illumination, and an infrared sensor. Each irradiation area is formed such that one or more different irradiation areas among the plurality of irradiation areas are selectively irradiated with the infrared radiation. The light source controller controls the infrared light source to adjust an illuminance of the for-camera infrared illumination on each irradiation area independently of each other on the basis of a sensor signal output from the infrared sensor for each of the plurality of irradiation patterns.

### BACKGROUND OF THE INVENTION

### 1. Field of the Invention

The present invention relates to on-board infrared illumination devices and relates, for example, to an on-board infrared illumination device for use in a vehicle, such as an automobile.

### 2. Description of the Related Art

There is conventionally known a night-vision system for automobile that uses infrared radiation. Such a system includes an LED lamp serving as an infrared light source provided at a front portion of the automobile and an infrared camera. The shutter of the camera opens at a timing at which the LED lamp turns on, and an image is captured by infrared radiation (see, for example, patent document 1).
[patent document 1] JP2002-274258

The present inventors have examined the night-vision system for automobile described above and come to recognize the following shortcomings. While the vehicle is traveling, the imaging range of the infrared camera often includes objects, such as road signs and delineators, having high reflectance. If illumination light from the infrared light source is reflected by such reflective bodies and enters the infrared camera, flare or halation may arise in the infrared camera image. According to one typical technique for suppressing a decrease in the image quality associated with such, the setting of the camera is changed, and for example, the gain of the infrared camera is lowered. However, a resulting camera image tends to be generally dark, and this may influence the visibility of the camera.

### SUMMARY OF THE INVENTION

The present invention has been made in view of such circumstances, and one exemplary object of one aspect of the present invention is to provide an on-board infrared illumination device that suppresses a decrease in the image quality of an on-board infrared camera.

To address the shortcomings described above, an on-board infrared illumination device according to one aspect of the present invention includes an infrared light source, a light source controller, and an infrared sensor. The infrared light source provides for-camera infrared illumination by irradiating, with infrared radiation, a plurality of irradiation areas included in an imaging range of an on-board infrared camera within an exposure time of the on-board infrared camera. The light source controller is configured to control the infrared light source to form a plurality of irradiation patterns at a timing different from a timing for the for-camera infrared illumination, and the plurality of irradiation patterns are each formed such that one or more different irradiation areas among the plurality of irradiation areas are selectively irradiated with the infrared radiation. The infrared sensor is disposed so as to receive infrared radiation reflected at the imaging range and outputs a sensor signal that is based on an intensity of the received infrared radiation. The light source controller is further configured to control the infrared light source to adjust an illuminance of the for-camera infrared illumination on each irradiation area independently of each other on the basis of the sensor signal output from the infrared sensor for each of the plurality of irradiation patterns.

According to this aspect, the illuminance of the for-camera infrared illumination on each irradiation area is adjusted independently of each other. For example, when reflected infrared radiation from a certain irradiation area is too intense, this irradiation area can be made dim relative to the others. Accordingly, flare or halation that could arise if the illuminance is not adjusted can be reduced or prevented, and a decrease in the image quality of the on-board infrared camera can be suppressed.

The timing different from the timing for the for-camera infrared illumination may be a timing outside the exposure time.

The plurality of irradiation areas may be arranged such that adjacent two of the plurality of irradiation areas partially overlap each other.

The infrared light source may be a first infrared light source that is one of a pair of infrared light sources disposed on right and left of a vehicle. The on-board infrared illumination device may further include a second infrared light source that is the other of the pair of infrared light sources. The first infrared light source may irradiate one of the two adjacent irradiation areas with infrared radiation. The second infrared light source may irradiate the other of the two adjacent irradiation areas with infrared radiation.

For each irradiation pattern, the one or more irradiation areas may be selected randomly from the plurality of irradiation areas.

The plurality of irradiation patterns may include a set of irradiation patterns formed such that the same irradiation area is irradiated with infrared radiation of a plurality of different illuminances.

The on-board infrared illumination device may further include the on-board infrared camera.

### BRIEF DESCRIPTION OF THE DRAWINGS

FIG. 1 is a block diagram illustrating an on-board infrared illumination device according to an embodiment;

FIG. 2 exemplarily illustrates a change over time in an optical detection signal, a driving current of each light emitting element, and a timing signal;

FIG. 3 is a flowchart illustrating an example of dimming control according to an embodiment;

FIG. 4 exemplarily illustrates a plurality of irradiation patterns;

FIG. 5 is a schematic diagram exemplarily illustrating an arrangement of irradiation areas;

FIG. 6 illustrates an automobile provided with an on-board infrared illumination device;

FIG. 7 is a schematic diagram illustrating another example of an arrangement of irradiation areas; and

FIG. 8 is a schematic diagram illustrating an optical unit.

### DETAILED DESCRIPTION OF THE INVENTION

The invention will now be described by reference to the preferred embodiments. This intends not to limit the scope of the present invention, but to exemplify the invention.

Hereinafter, the present invention will be described on the basis of some preferred embodiments with reference to the drawings. The embodiments are illustrative in nature and are not intended to limit the invention. Not all the features and combinations thereof described with respect to the embodiments are necessarily essential to the invention. Identical or equivalent constituent elements, members, and processes illustrated in the drawings are given identical reference characters, and duplicate descriptions thereof will be omitted, as appropriate. The scales and the shapes of the components illustrated in the drawings are set merely for convenience to facilitate the descriptions and are not to be interpreted as limiting the invention, unless specifically indicated otherwise. Terms such as “first” and “second” used in the present specification and in the claims do not indicate the order or the degree of importance in anyway and are merely for distinguishing a given configuration from one or more other configurations. Any member or members that are not important in describing the embodiments are omitted from the drawings.

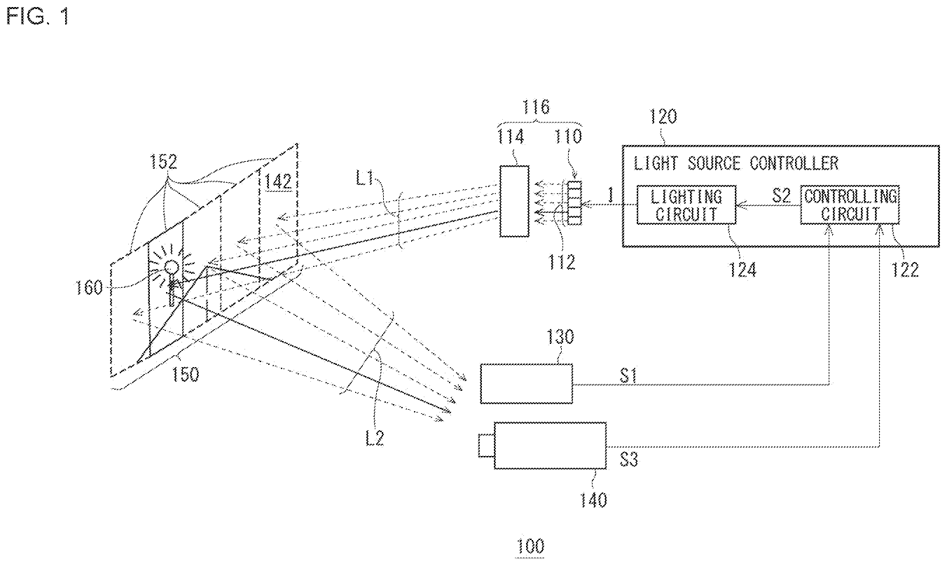

FIG. 1 is a block diagram illustrating an on-board infrared illumination device 100 according to an embodiment. FIG. 1 depicts some of the constituent elements of the on-board infrared illumination device 100 as functional blocks. These functional blocks are implemented, in terms of their hardware configuration, by elements and/or circuits, such as a CPU or a memory of a computer, or implemented, in terms of their software configuration, by a computer program or the like. It is to be appreciated by a person skilled in the art that these functional blocks can be implemented in a variety of forms through combinations of hardware and software.

The on-board infrared illumination device 100 includes an infrared light source 110, a light source controller 120, and an infrared sensor 130. The on-board infrared illumination device 100, along with an on-board infrared camera 140, constitutes an on-board imaging device. The on-board infrared camera 140 may be regarded as a constituent element of the on-board infrared illumination device 100. In this example, the on-board infrared illumination device 100 uses, for example, near-infrared radiation as infrared radiation.

The infrared light source 110 provides for-camera infrared illumination by irradiating, with infrared radiation L1, a plurality of irradiation areas 152 included in an imaging range 142 of the on-board infrared camera 140 within an exposure time of the on-board infrared camera 140. The plurality of irradiation areas 152 are defined and arranged adjacent to each other within the imaging range 142 of the on-board infrared camera 140. In this example, the imaging range 142 is divided into five areas. The imaging range 142, however, may be divided into any number of areas and may be divided into more five areas or less than five areas. With regard to the arrangement of the irradiation areas 152, although the irradiation areas 152 are arrayed in the right-left direction in this example, the irradiation areas 152 may be arrayed in a variety of other manners and may, for example, be arrayed in lengthwise and crosswise directions.

The infrared light source 110 includes a plurality of light emitting elements 112. Each light emitting element 112 is an infrared LED according to the present embodiment, but there is no particular limitation thereto, and each light emitting element 112 may be a semiconductor light emitting element or any other desired light emitting element. The infrared light source 110, along with an optical system 114, constitutes an optical unit 116.

Each light emitting element 112 irradiates its corresponding irradiation area 152 with the infrared radiation L1 through the optical system 114. One light emitting element 112 is associated with each irradiation area 152. Therefore, in this example, the infrared light source 110 includes five light emitting elements 112. The light emitting elements 112 can be turned on or off independently of each other, and the infrared light source 110 can irradiate the irradiation areas 152 independently of each other. Alternatively, a plurality of light emitting elements 112 may be associated with each irradiation area 152, and the plurality of light emitting elements 112 may irradiate their corresponding one irradiation area 152.

The infrared light source 110 may include an array of light emitting elements in which the plurality of light emitting elements 112 are arrayed one-dimensionally or two-dimensionally. The number of the light emitting elements 112 is not limited, and there may be 10 or more light emitting elements 112, for example. The number of the light emitting element 112 may be no more than 100, for example.

To provide for-camera infrared illumination, the light source controller 120 operates the infrared light source 110 so as to irradiate the plurality of irradiation areas 152 with the infrared radiation L1. The plurality of irradiation areas 152 may be irradiated simultaneously. The plurality of irradiation areas 152 may be irradiated successively with the irradiation area 152 to be irradiated switched.

The light source controller 120 controls the infrared light source 110 so as to form a plurality of irradiation patterns 150 at a timing different from the timing for the for-camera infrared illumination. Each of the plurality of irradiation patterns 150 is formed as one or more irradiation areas 152 among the plurality of irradiation areas 152 are selectively irradiated with the infrared radiation. The plurality of irradiation patterns 150 differ from each other in terms of the irradiation area 152 or irradiation areas 152 that are irradiated. For example, the light source controller 120 operates the infrared light source 110 so as to irradiate the plurality of irradiation areas 152 successively with the irradiation area 152 to be irradiated switched at a timing outside the exposure time of the on-board infrared camera 140. In this manner, the plurality of irradiation patterns 150 are used as for-sensor infrared illumination.

The timing different from the timing for the for-camera infrared illumination is a timing outside the exposure time of the on-board infrared camera 140 and is, for example, a non-exposure time that lies between two consecutive exposure times. In this manner, the for-camera infrared illumination and the for-sensor infrared illumination are set at mutually different timings.

The light source controller 120 controls the infrared light source 110 so as to adjust the illuminance of the for-camera infrared illumination on the irradiation areas 152 independently of each other on the basis of a sensor signal S1 output from the infrared sensor 130 for each of the plurality of irradiation patterns 150. The light source controller 120 can turn on and control the brightness of each light emitting element 112 of the infrared light source 110 independently of each other.

The light source controller 120 includes a controlling circuit 122 and a lighting circuit 124. The controlling circuit 122 generates a dimming signal S2 on the basis of a sensor signal S1. A dimming signal S2 is set so as to cause the light emitting elements 112 to emit light in pulses simultaneously or at different timings. A dimming signal S2 may be a pulse width modulation (PWM) signal. The lighting circuit 124 supplies a pulsed driving current I to each light emitting element 112 in accordance with a dimming signal S2. The magnitude of the driving current I is controlled in accordance with the dimming signal S2, and the intensity of the pulsed light emission from each light emitting element 112 is controlled each time.

Each light emitting element 112 emits light at a luminance corresponding to the driving current I, and each irradiation area 152 is illuminated at a corresponding illuminance as a result. As each light emitting element 112 emits light in pulses in accordance with a dimming signal S2, the irradiation areas 152 are irradiated with the infrared radiation L1, and the imaging range 142 is illuminated with the infrared radiation L1. The infrared radiation L1 from the infrared light source 110 may be reflected at each irradiation area 152. The infrared radiation reflected at the irradiation areas 152 (this may also be referred to below simply as reflected light L2) enters the infrared sensor 130 and the on-board infrared camera 140.

The infrared sensor 130 is disposed so as to receive reflected light L2 from the imaging range 142 and outputs a sensor signal S1 that is based on the intensity of the received reflected light L2. The infrared sensor 130 is sensitive to the wavelength of the infrared radiation that the infrared light source 110 emits. The infrared sensor 130 may be, for example, a single-pixel photodetector. A sensor signal S1 is input to the light source controller 120.

When the imaging range 142 is irradiated successively with the plurality of irradiation patterns 150 serving as for-sensor infrared illumination, the infrared sensor 130 receives reflected light L2 from the infrared light source 110 for each of the plurality of irradiation patterns 150 and outputs sensor signals S1 successively. Each sensor signal S1 indicates the intensity of the reflected light L2 for its corresponding irradiation pattern 150. Each sensor signal S1 may be a spatial integral of the intensity distribution of the reflected light L2 that the infrared sensor 130 has received.

The on-board infrared camera 140 outputs, to the light source controller 120, a timing signal S3 indicating an exposure timing of the on-board infrared camera 140. A timing signal S3 is output from the on-board infrared camera 140 at a frame rate coordinated with the exposure time of the on-board infrared camera 140. The light source controller 120 grasps the start and the end of an exposure time of the on-board infrared camera 140 on the basis of a timing signal S3. The light source controller 120 controls the infrared light source 110 in synchronization with exposure timings of the on-board infrared camera 140 so as to provide for-camera infrared illumination in an exposure time of the on-board infrared camera 140 and provide for-sensor infrared illumination in a non-exposure time.

To illustrate one example of the irradiation patterns 150, FIG. 1 illustrates a state in which the fourth irradiation area 152 from the right as viewed from the vehicle is irradiated with the infrared radiation L1 and the remaining irradiation areas 152 are not irradiated with the infrared radiation L1.

While the vehicle is traveling, the imaging range 142 often includes an object, such as a road sign or a delineator, having high reflectance (referred to below as a reflective body 160). As one example, FIG. 1 illustrates a situation in which a reflective body 160 is located in the fourth irradiation area 152 being irradiated with the infrared radiation L1. Therefore, the reflective body 160 shines brightly by the infrared radiation L1 and radiates intense reflected light L2.

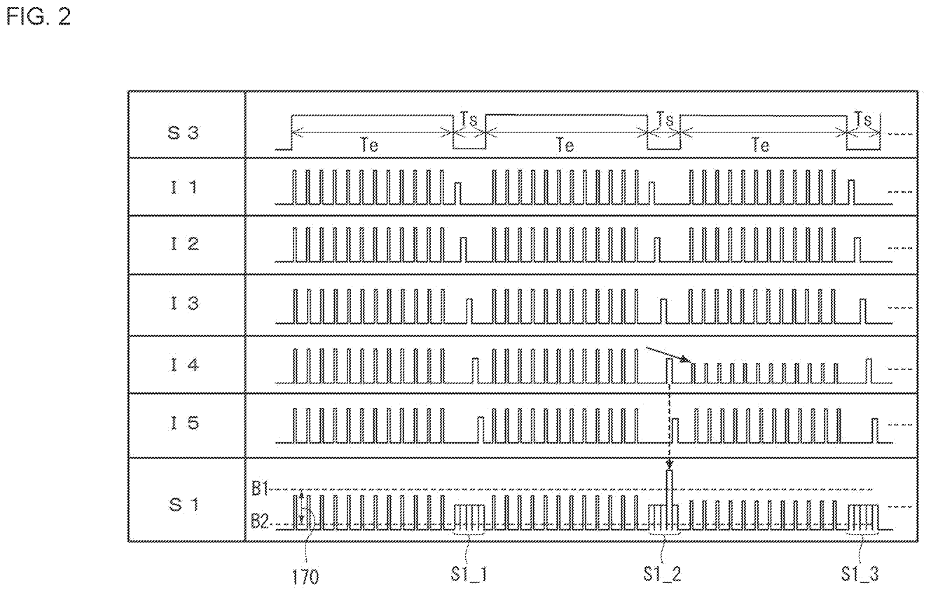

FIG. 2 exemplarily illustrates a change over time in a sensor signal S1, driving currents I1 to I5 of respective light emitting elements 112, and a timing signal S3. The driving currents I1 to I5 correspond to the five irradiation areas 152 illustrated in FIG. 1. Each exposure time Te is indicated by the timing signal S3, and a non-exposure time Ts falls between two consecutive exposure times Te. The frame rate of the on-board infrared camera 140 is, for example, 30 fps (i.e., one frame includes about 33 milliseconds), and the exposure time per frame is, for example, 30 milliseconds.

In for-camera infrared illumination provided in each exposure time Te, the pulse waveforms of the driving currents I1 to I5 of the respective light emitting elements 112 are in phase. Therefore, the light emitting elements 112 irradiate the corresponding irradiation areas 152 simultaneously with the infrared radiation L1. Each of the driving currents I1 to I5 of the respective light emitting elements 112 includes a plurality of pulses (12 pulses in the example illustrated in FIG. 2) within a single exposure time Te. In this example, the pulse cycle and the pulse duration are retained at default values but may be changed as necessary.

In for-sensor infrared illumination provided in each non-exposure time Ts, the pulse waveforms of the driving currents I1 to I5 of the respective light emitting elements 112 are out of phase. Therefore, the light emitting elements 112 emit light in pulses successively, and their corresponding irradiation areas 152 are irradiated successively with the emitted light.

When the imaging range 142 of the on-board infrared camera 140 includes no reflective body 160, a sensor signal S1 is contained within a permitted range 170 defined by an upper threshold B1 and a lower threshold B2. The upper threshold B1 and the lower threshold B2 can be set as appropriate on the basis of the designer's experience-based knowledge or experiments or simulations conducted by the designer. The upper threshold B1 and the lower threshold B2 may be held in advance in an internal memory of the light source controller 120.

When the imaging range 142 includes a reflective body 160, a sensor signal S1 may exceed the upper threshold B1 to go outside the permitted range 170, as will be described later. When a sensor signal S1 goes outside the permitted range 170, the light source controller 120 controls the driving currents I1 to I5 of the respective light emitting elements 112 so as to bring back the sensor signal S1 to fall within the permitted range 170.

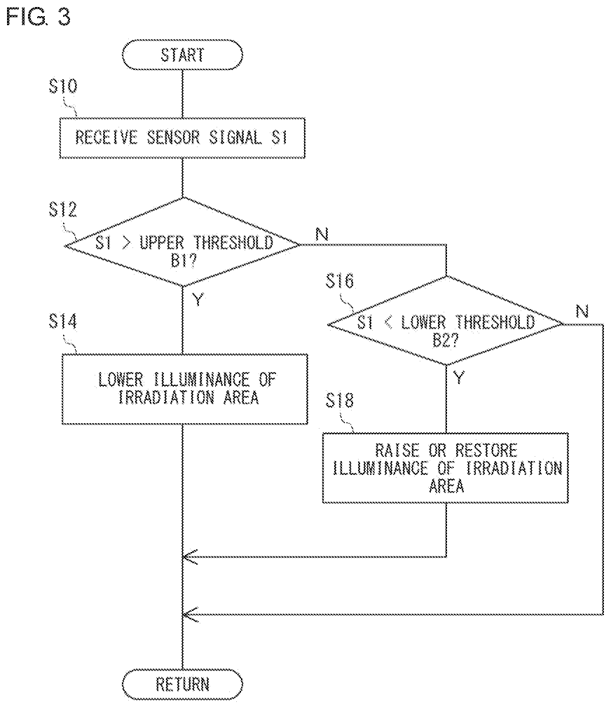

FIG. 3 is a flowchart illustrating an example of dimming control according to an embodiment. This dimming control process is executed by the controlling circuit 122 of the light source controller 120. The dimming control process is executed in parallel for the plurality of irradiation areas 152. The controlling circuit 122 receives a timing signal S3 and executes the dimming control process for each irradiation area 152 during a non-exposure time Ts following one exposure time Te corresponding to the received timing signal S3.

First, the controlling circuit 122 receives a sensor signal S1 from the infrared sensor 130 (S10). Since the plurality of irradiation areas 152 are irradiated successively by the infrared light source 110 with the irradiation area 152 to be irradiated switched as described above, sensor signals S1 for the respective irradiation areas 152 are input to the controlling circuit 122 successively.

The controlling circuit 122 compares each sensor signal S1 against the upper threshold B1 (S12). If any sensor signal S1 exceeds the upper threshold B1 (Y at S12), the controlling circuit 122 lowers the illuminance of the corresponding irradiation area 152 (S14). Specifically, the controlling circuit 122 generates a dimming signal S2 so as to reduce the driving current I of the light emitting element 112 that irradiates the corresponding irradiation area 152 with the infrared radiation L1. With this operation, an irradiation area 152 that is too bright due to a reflective body 160 can be selectively dimmed to reduce or prevent halation.

Meanwhile, if none of the sensor signals S1 exceeds the upper threshold B1 (N at S12) and if any sensor signal S1 falls below the lower threshold B2 (Y at S16), the controlling circuit 122 raises or restores the illuminance of the corresponding irradiation area 152 (S18). The controlling circuit 122 generates a dimming signal S2 so as to increase the driving current I of the light emitting element 112 that irradiates the corresponding irradiation area 152 with the infrared radiation L1. With this operation, the brightness of the irradiation area 152 that is too dim can be restored to ensure the field of view favorable for the on-board infrared camera 140.

If a given sensor signal S1 does not fall below the lower threshold B2 (N at S16), the controlling circuit 122 retains the illuminance of the corresponding irradiation area 152. With this operation, the brightness of the irradiation area 152 with appropriate brightness can be retained to ensure the field of view favorable for the on-board infrared camera 140.

The amount by which the driving current I is reduced may stay constant regardless of the value of the sensor signal S1. Alternatively, the amount by which the driving current I is reduced may vary in accordance with the value of the sensor signal S1. For example, the driving current I may be reduced by a larger amount as the difference between the sensor signal S1 and the upper threshold B1 is greater. In a similar manner, the amount by which the driving current I is increased may stay constant regardless of the value of the sensor signal S1. Alternatively, the amount by which the driving current I is increased may vary in accordance with the value of the sensor signal S1. For example, the driving current I may be increased by a larger amount as the difference between the sensor signal S1 and the lower threshold B2 is greater.

Once the vehicle passes the reflective body 160, the sensor signal S1 that has exceeded the upper threshold B1 should return to fall within the permitted range 170. In other words, that the sensor signal S1 exceeds the upper threshold B1 is a temporary phenomenon. Therefore, instead of comparing the sensor signal S1 against the lower threshold B2, the controlling circuit 122, upon lowering the illuminance of a given irradiation area 152, may restore or gradually increase the illuminance of the irradiation area 152 to its initial value (i.e., the illuminance held before the illuminance has been reduced) after a predetermined time has passed.

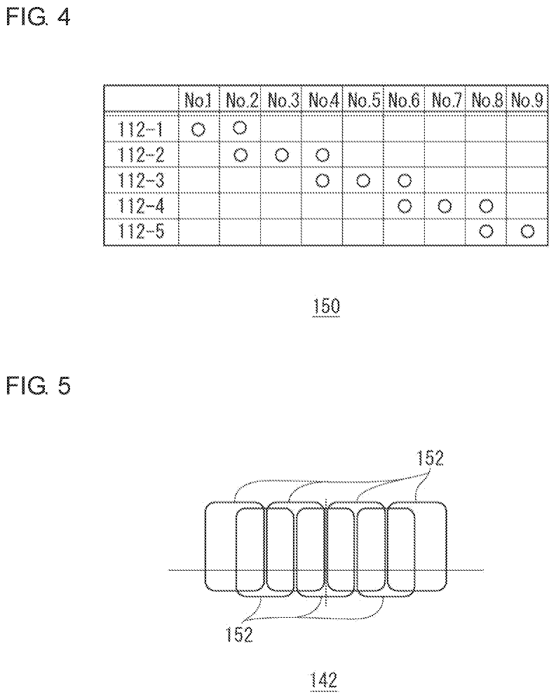

FIG. 4 exemplarily illustrates a plurality of irradiation patterns 150. For each of the five light emitting elements 112-1 to 112-5, the open circle indicates that the corresponding light emitting element is on, and the blank means that the light emitting element is off. FIG. 4 illustrates nine irradiation patterns 150, but this merely illustrates an example. The irradiation pattern 150 illustrated in FIG. 1 corresponds to No. 7 in FIG. 4.

Referring back to FIG. 2, an operation example of the on-board infrared illumination device 100 will be described. FIG. 2 exemplarily illustrates a change over time in the sensor signal S1, the driving currents I1 to I5 of the respective light emitting elements 112, and the timing signal S3 for three consecutive frames. In the case considered here as one example, no reflective body 160 is present in the imaging range 142 in the first frame of the three frames, and a reflective body 160 appears in the fourth irradiation area 152 as illustrated in FIG. 1 in the second frame.

For-camera infrared illumination is provided in the exposure time Te in the first frame. Synchronous pulsed driving currents I1 to I5 are supplied to the respective light emitting elements 112, and the five irradiation areas 152 are irradiated simultaneously with the pulsed infrared radiation L1.

Upon grasping the end of the exposure time Te in the first frame on the basis of the timing signal S3, the light source controller 120 switches the infrared light source 110 from the for-camera infrared illumination to the for-sensor infrared illumination. For-sensor infrared illumination is provided in the non-exposure time Ts. Pulsed driving currents I1 to I5 are supplied successively to the respective light emitting elements 112, and the irradiation areas 152 are irradiated successively with the infrared radiation L1. The on-board infrared camera 140 receives the reflected light L2 from each irradiation area 152 and outputs, to the light source controller 120, a sensor signal S1_1 corresponding to the intensity of the received reflected light L2.

Since none of the irradiation areas 152 includes a reflective body 160 at this point, the sensor signals S1_1 are constant across the irradiation areas 152 and are contained within the permitted range 170. Therefore, the illuminance of each irradiation area 152 in the exposure time Te in the second frame is retained to the illuminance equal to that in the first frame.

Upon grasping the start of the exposure time Te in the second frame on the basis of the timing signal S3, the light source controller 120 switches the infrared light source 110 from the for-sensor infrared illumination to the for-camera infrared illumination. As with the first frame, each irradiation area 152 is irradiated with the infrared radiation L1. Upon the end of the exposure time Te, for-sensor infrared illumination is provided.

Since the fourth irradiation area 152 includes a reflective body 160 at this point in this example, a sensor signal S1_2 exceeds the upper threshold B1 in synchronization with the driving current pulse (I4) supplied to the corresponding fourth light emitting element 112. The sensor signals S1_2 for the remaining irradiation areas 152 are contained within the permitted range 170.

Accordingly, the dimming signal S2 is controlled by the light source controller 120. Thus, the driving current I4 of the fourth light emitting element 112 is reduced for the for-camera illumination in the third frame, and the driving currents I1 to I3 and I5 of the respective remaining light emitting elements 112 are retained. In this manner, the illuminance of the fourth irradiation area 152 that includes the reflective body 160 is lowered in the exposure time Te in the third frame.

Thereafter, for-sensor illumination is provided in a similar manner in the non-exposure time Ts in the third frame, and sensor signals S1_3 are acquired. Since the illuminance of the fourth irradiation area 152 has been lowered, the reflected light L2 associated with the reflective body 160 is reduced. Therefore, the sensor signals S1_3 are contained within the permitted range 170 for all the irradiation areas 152 including the fourth irradiation area 152.

In this manner, the on-board infrared illumination device 100 can adjust the illuminance of each irradiation area 152 independently of each other on the basis of the sensor signal S1 and make the irradiation area 152 that includes a reflective body 160 dim relative to the others. Accordingly, flare or halation that could arise if the light is not adjusted can be reduced or prevented, and a decrease in the image quality of the on-board infrared camera 140 associated with the reflected light L2 from the infrared light source 110 can be suppressed.

The embodiment can provide a self-sensing on-board infrared illumination device 100 that itself detects the reflected light L2 from the infrared light source 110 and creates a light distribution suitable for the on-board infrared camera 140. When the camera setting is changed by, for example, reducing the gain to prevent halation, the image tends to become generally dark. However, the on-board infrared illumination device 100 selectively dims a glaring irradiation area 152, and thus the above-described problem is alleviated or resolved. Typically, a glaring local region is identified through image processing. The embodiment, however, provides an advantage in that such a glaring local region can be identified through a simple configuration without involving a complex technique.

For-sensor infrared illumination is provided at a timing outside the exposure times Te of the on-board infrared camera 140. Therefore, for-sensor infrared illumination has no influence on the imaging performed by the on-board infrared camera 140. Moreover, for-sensor infrared illumination can be set to irradiation patterns 150 suitable for the infrared sensor 130.

Nowadays, there is proposed a technique called ghost imaging. Instead of an image sensor of a two-dimensional array as in typical imaging, a point photodetector with no spatial resolution is used. Along with the point photodetector, illumination with a number of irradiation patterns that are spatially modulated (typically randomly) is used. The reflected light from an irradiated object is detected with the point photodetector for each irradiation pattern, and the correlation between the intensity of the reflected light and the irradiation pattern is obtained. Thus, an image of the irradiated object can be generated.

Accordingly, for each irradiation pattern 150, one or more irradiation areas 152 to be irradiated may be selected randomly from the plurality of irradiation areas 152. The light source controller 120 may control the infrared light source 110 so as to form a plurality of irradiation patterns 150 in each of which the irradiation area 152 or irradiation areas 152 are selected randomly. In this manner, the on-board infrared illumination device 100 can provide for-sensor infrared illumination suitable for ghost imaging.

Making available a larger number of irradiation patterns 150 can increase the resolution of ghost imaging. From such a standpoint, some modification examples regarding the arrangement of the irradiation areas 152 will be described.

FIG. 5 is a schematic diagram exemplarily illustrating an arrangement of the irradiation areas 152. As illustrated in FIG. 5, the plurality of irradiation areas 152 may be arranged such that two adjacent irradiation areas 152 partially overlap each other. This arrangement can increase the number of irradiation areas 152 included in the imaging range 142, and thus the on-board infrared illumination device 100 can form a larger number of irradiation patterns 150.

The plurality of irradiation patterns 150 may include a set of irradiation patterns 150 that is formed as the same irradiation areas 152 are irradiated with infrared radiation of different illuminances. With this configuration, the on-board infrared illumination device 100 can form a larger number of irradiation patterns 150 by combining not only the on/off of the irradiation areas 152 but also the illuminance of the irradiation areas 152.

The light source controller 120 may control the infrared light source 110 so as to irradiate with all the irradiation patterns 150 in one instance of for-sensor infrared illumination (e.g., in one non-exposure time Ts). This irradiation method is suitable when the number of irradiation patterns 150 is relatively small.

Alternatively, the light source controller 120 may selectively assign one or more irradiation patterns 150 to one instance of for-sensor infrared illumination and control the infrared light source 110 so as to irradiate in all the irradiation patterns 150 through a plurality of instances of for-sensor infrared illumination. This irradiation method is suitable when the number of irradiation patterns 150 is relatively large.

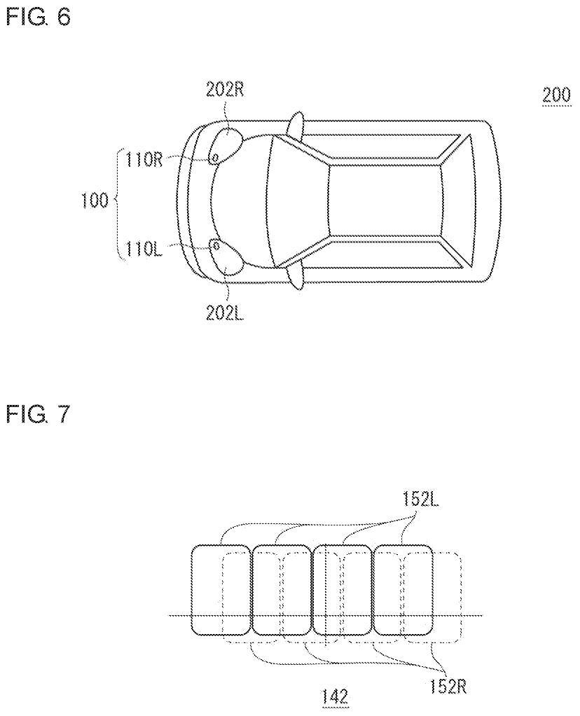

FIG. 6 illustrates an automobile provided with the on-board infrared illumination device 100. An automobile 200 includes headlamps 202L and 202R. The on-board infrared illumination device 100 is incorporated into each of the headlamps 202L and 202R. Therefore, the headlamp 202L is provided with a first infrared light source 110L, and the headlamp 202R is provided with a second infrared light source 110R.

FIG. 7 is a schematic diagram illustrating another example of an arrangement of the irradiation areas 152. Some irradiation areas 152L may be irradiated by the first infrared light source 110L illustrated in FIG. 6, and the remaining irradiation areas 152R may be irradiated by the second infrared light source 110R. The first infrared light source 110L may irradiate one irradiation area 152L of two adjacent irradiation areas with infrared radiation, and the second infrared light source 110R may irradiate the other irradiation area 152R of the two adjacent irradiation areas with infrared radiation. This configuration can increase the number of irradiation areas 152 included in the imaging range 142, and thus the on-board infrared illumination device 100 can form a larger number of irradiation patterns 150.

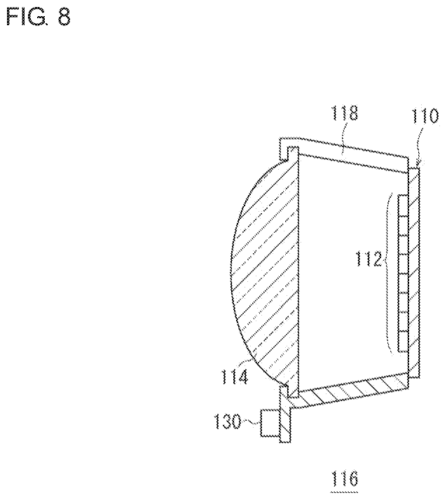

FIG. 8 is a schematic diagram illustrating the optical unit 116. The optical unit 116 includes the infrared light source 110 including the plurality of light emitting elements 112, the optical system 114 constituted, for example, by a projection lens, and a holder 118 that secures the infrared light source 110 and the optical system 114 to each other.

The infrared sensor 130 may be secured to the optical unit 116. The infrared sensor 130 may be attached to the holder 118 so that the infrared sensor 130 is disposed close to the optical system 114, for example.

In a lamp, such as a headlamp, provided in a vehicle, light distribution control such as adaptive driving beam (ADB) control may be executed, for example. While vehicle lamps are disposed on the front right and the front left of the vehicle, a front vehicle detecting device (e.g., a camera) for controlling the light distribution is often disposed at the center position in the widthwise direction of the vehicle. Due to the difference in the position where they are disposed, an angular difference called the parallax angle exists between the angle in which the front vehicle is viewed from the detecting device and the angle of the optical axis of the lamp.

When the optical unit 116 is incorporated in each of the headlamps 202L and 202R, the infrared sensor 130 is located close to the optical axis of the corresponding lamp. Therefore, the position information of the front vehicle acquired by the infrared sensor 130 may be used to correct the parallax angle in the light distribution control of the vehicle lamps.

The present invention is not limited to the foregoing embodiments and modification examples. The embodiments and the modification examples can be combined, or further modifications, including various design changes, can be made to the foregoing embodiments and modification examples on the basis of the knowledge of a person skilled in the art. An embodiment or a modification example obtained through such combinations or by making further modifications is also encompassed by the scope of the present invention. The foregoing embodiments and modification examples and a new embodiment obtained by combining the foregoing embodiments and modification examples with the following modifications have advantageous effects of each of the combined embodiments, modification examples, and further modifications.

According to the foregoing embodiments, for-sensor infrared illumination is provided in the non-exposure times Ts of the on-board infrared camera 140. Alternatively, the light source controller 120 may control the infrared light source 110 so as to provide for-sensor infrared illumination in the exposure times Te. For example, in a first period of an exposure time Te, the light source controller 120 may operate the infrared light source 110 so as to irradiate the plurality of irradiation areas 152 successively with the irradiation area 152 to be irradiated switched and acquire a sensor signal S1 for each of the plurality of irradiation areas 152. In a second period of this exposure time Te following the first period of the exposure time Te, the light source controller 120 may operate the infrared light source 110 so as to irradiate one or more or all of the irradiation areas 152 among the plurality of irradiation areas 152 simultaneously and control the infrared light source 110 so as to adjust the illuminance of each irradiation area 152 independently of each other on the basis of the sensor signals S1 acquired in the first period.

The present invention has been described on the basis of embodiments with the use of specific terms, but the embodiments merely illustrate the principle and one aspect of the applications of the present invention, and a number of modifications of the embodiments and changes in the arrangement can be made within a scope that does not depart from the spirit of the present invention set forth in the claims.

What is claimed is:

1. An on-board infrared illumination device, comprising:
an infrared light source that provides for-camera infrared illumination by irradiating, with infrared radiation, a plurality of irradiation areas included in an imaging range of an on-board infrared camera within an exposure time of the on-board infrared camera;
a light source controller configured to control the infrared light source to form a plurality of irradiation patterns at a timing different from a timing for the for-camera infrared illumination, the plurality of irradiation patterns each being formed such that one or more different irradiation areas among the plurality of irradiation areas are selectively irradiated with the infrared radiation; and
an infrared sensor that is disposed so as to receive infrared radiation reflected at the imaging range and outputs a sensor signal that is based on an intensity of the received infrared radiation, wherein
the light source controller is further configured to control the infrared light source to adjust an illuminance of the for-camera infrared illumination on each irradiation area independently of each other on the basis of the sensor signal output from the infrared sensor for each of the plurality of irradiation patterns.

2. The on-board infrared illumination device according to claim 1, wherein
the timing different from the timing for the for-camera infrared illumination is a timing outside the exposure time.

3. The on-board infrared illumination device according to claim 1, wherein
the plurality of irradiation areas are arranged such that adjacent two of the plurality of irradiation areas partially overlap each other.

4. The on-board infrared illumination device according to claim 3, wherein
the infrared light source is a first infrared light source that is one of a pair of infrared light sources disposed on right and left of a vehicle,
the on-board infrared illumination device further includes a second infrared light source that is the other of the pair of infrared light sources,
the first infrared light source irradiates one of the two adjacent irradiation areas with infrared radiation, and
the second infrared light source irradiates the other of the two adjacent irradiation areas with infrared radiation.

5. The on-board infrared illumination device according to claim 1, wherein
for each irradiation pattern, the one or more irradiation areas are selected randomly from the plurality of irradiation areas.

6. The on-board infrared illumination device according to claim 1, wherein
the plurality of irradiation patterns include a set of irradiation patterns formed such that the same irradiation area is irradiated with infrared radiation of a plurality of different illuminances.

7. The on-board infrared illumination device according to claim 1, further comprising:
the on-board infrared camera.
